(19) United States
(12) Patent Application Publication
(10) Pub. No.: US 2026/0228199 A1
(43) Pub. Date: Aug. 6, 2026

(54) FLEXIBLE WORK DIVISION FOR PARALLEL IN-MEMORY HIERARCHICAL NAVIGABLE SMALL WORLD VECTOR INDEX CONSTRUCTION IN A RELATIONAL DATABASE MANAGEMENT SYSTEM

(71) Applicant: Oracle International Corporation, Redwood Shores, CA (US)

(72) Inventors: Ioannis Alagiannis, Zurich (CH); Marco Arnaboldi, Zurich (CH); Martin Brugnara, Zurich (CH); Damien Hilloulin, Zurich (CH); Laurent Phillipe Daynes, Saint-Ismier (FR); Vlad Ioan Haprian, Zurich (CH)

(21) Appl. No.: 19/045,694

(22) Filed: Feb. 5, 2025

(51) Int. Cl. G06F 16/22; G06F 9/50; G06F 16/25

(52) U.S. Cl. CPC G06F 16/2237; G06F 9/5066; G06F 16/25

(57) ABSTRACT

The present disclosure relates to flexible work division for efficient parallel in-memory HNSW vector index construction in a database management system (DBMS). The DBMS may store in memory representations of a plurality of vectors from a database. A plurality of workers may ingest, in parallel, the plurality of vectors into a hierarchical navigable small world (HNSW) vector index stored in memory. The HNSW vector index may index the plurality of vectors. An individual worker of the plurality of workers ingesting one or more vectors of the plurality of vectors into the HNSW vector index may comprise: the individual worker creating a task to ingest a range of vectors of the one or more vectors into the HNSW vector index and the individual worker ingesting individual vectors of the range of vectors into the HNSW vector index.

### TECHNICAL FIELD

The present disclosure relates to indexes for performing approximate similarity searches over vector data.

### BACKGROUND

In data science, similarity search often appears in the natural language processing (NLP) domain, in search engines, and in recommender systems in which relevant documents or other items are retrieved for a query. Demand is growing for methods to perform similarity search on data that resides in relational databases. Previous solutions have used vector databases constructed outside a database storing data of interest, such as a relational database. For example, vector indexes can be constructed in dedicated similarity search engines. As another example, data can be migrated to a vector database.

These solutions, however, substantially increase the complexity of data management and lead to significant loading and data transfer costs for external engines. Further, these solutions are not practical in the presence of data manipulation language (DML) statements like insertions and deletions that are common in enterprise environments.

Relational databases can be extended with new data types such as the VECTOR data type, with SQL operators that enable the creation of vectors over existing or new database tables, or with similarity search capabilities. But without special support, performance of the similarity search will be worse than the performance offered by dedicated vector engines. In particular, a main-memory vector index allowing fast navigation through vectors significantly increases performance.

Hierarchical navigable small world (HNSW) can be used for an approximate similarity search. HNSW has proven to yield the highest performance in terms of recall and query per second (QPS) metrics. The recall metric represents the number of correct results that are returned from a top-K similarity search; a recall of 1 means that all the results are “true positives”, while a recall of 0 means that all the results are “false positives”. A top-K similarity search is a search for the k most similar vectors in a dataset to a query vector. A top-K approximate similarity search may reduce the recall metric of a top-k similarity search to some degree—meaning that the k results of such a search may not be, in fact, the K most similar vectors—in exchange for reducing the cost of the search. Similarity may be expressed using a distance function between vectors in a vector space such as, for example, Euclidean distance or cosine distance.

Similarity vector engines can use graph indexes stored in main memory to speed up similarity search workloads. One example is RDBMSs with vector analytics features, which include databases built on top of an entity-relationship model. This kind of RDBMS allows both in-memory features to speed up queries and some graph supports. Another example is vector processing libraries including vector engines that work outside of data stores—meaning that vector data is exported and transferred from the RDBMs to the vector engine system. An HNSW index may be constructed in external memory. Different loaders can be used to construct the HNSW index depending on the vector engine and the format in which the vector data is exported. An additional example is vector database systems, which include systems specifically optimized to map, store, and explore vector datasets. Data can be directly created, stored, and managed in the vector database.

One challenge in using HNSW is quick and efficient construction of the index. Intra-process and/or inter-process parallelism can be exploited to accelerate in-memory HNSW vector index construction. HNSW vector index construction can be partitioned into independent units of work, tasks, that can be processed in parallel. The processing time of each task, however, could vary significantly because of the characteristics of the HNSW vector index, leading to load imbalance. Thus, it would be beneficial to develop techniques of work division that properly associate tasks to the available resources (e.g., CPU cores, threads).

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example database management system (DBMS), in an embodiment.

FIG. 2 is a flow diagram that illustrates an example of a process for parallel HNSW vector index construction, in an embodiment.

FIG. 3 is a chart diagram that illustrates an example of load imbalance among workers during parallel HNSW vector index construction, in an embodiment.

FIG. 4 is a flow diagram that illustrates an example of a process for work division during parallel HNSW vector index construction, in an embodiment.

FIG. 5 is a flow diagram that illustrates an example of a process for creating a task to ingest a range of vectors in an HNSW vector index, in an embodiment.

FIG. 6 is a block diagram that illustrates a computer system upon which an embodiment of the invention may be implemented.

FIG. 7 is a block diagram of a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The present disclosure relates to flexible work division for efficient parallel in-memory HNSW vector index construction in a DBMS, such as a RDBMS. The flexible work division approach introduces new capabilities for efficient parallel in-memory HNSW vector index construction for vector values stored in a column of a relational table. The flexible work division approach speeds up parallel in-memory HNSW vector index construction, improves the use of computing resources, and overcomes technical problems that cause load imbalances, all without requiring the use of specialized hardware like a graphics processing unit (GPU). The disclosed approach enables load balancing that combines flexible fine-grain task work division with lazy task creation. The flexible work division approach achieves load balance without introducing additional overhead in the search process or degrading recall while still reducing the time to perform parallel HNSW vector index ingestion.

The techniques described herein may extend a parallel construction approach for parallel in-memory HNSW vector index construction with a new work division approach that enables dynamically splitting index construction into fine-grain tasks that can be processed independently. An example of such a parallel construction algorithm for in-memory HNSW vector index construction is described in U.S. application Ser. No. 19/038,504 (Atty. Docket. No. 50277-6371), filed on Jan. 27, 2025, the contents of which are incorporated by reference herein in their entirety. The disclosed techniques maintain the advantages described in U.S. application Ser. No. 19/038,504 (Atty. Docket. No. 50277-6371) while introducing several further improvements.

For example, the disclosed techniques may include a novel work division approach that creates fine-grain tasks tailored to parallel in-memory HNSW vector index construction. Fine-grain tasks may help to alleviate load imbalance issues with coarse-grain tasks—where each worker is assigned a task to ingest an equal number of vectors. An individual fine-grain task may include ingesting a range of vectors. Fine-grained tasks may be sized based on characteristics of the HNSW vector index, temporal constraints, or other factors.

As another example, the disclosed techniques may include a novel lazy task creation approach. Instead of pre-scheduling tasks, a worker may create a new task to ingest a range of vectors each time the worker finishes a task. The workers may use a shared latch on the list of vectors to ingest to ensure that no two workers attempt to ingest the same or overlapping ranges of vectors—which imposes little-to-no overhead on the parallel vector ingestion process. The lazy task creation approach thereby avoids expensive synchronization and decouples task creation from the task-to-worker assignment.

### System Overview

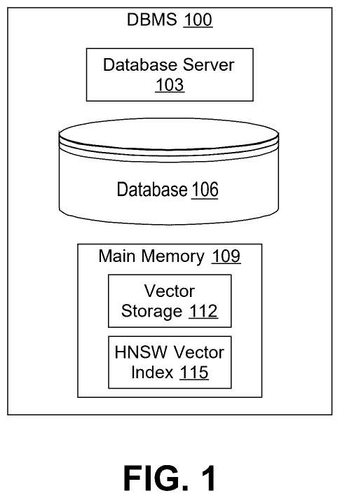

FIG. 1 is a block diagram that depicts an example database management system (DBMS) 100, in an embodiment. DBMS 100 comprises a database server 103 and a database 106. Database server 103 is communicatively coupled to database 106. DBMS 100 may be deployed in a network of an enterprise or may be deployed in a cloud environment and, therefore, may be accessible to an enterprise over one or more computer networks (e.g., the Internet). DBMS 100 may be provisioned for an enterprise by a cloud management team of a cloud provider as needed on an enterprise-by-enterprise basis.

Database server 103 comprises one or more computing machines, each executing one or more compute instances that receive and process data requests, including data retrieval requests (e.g., queries) and data modification requests (i.e., for vector data modifications), such as inserting vectors, deleting vectors, and updating vectors. Database 106 may comprise multiple storage devices, each storing data potentially including vector data. A computing instance translates a data request into a storage layer request that the computing instance transmits to database 106. A computing machine that hosts at least one compute instance includes (1) one or more processors, (2) volatile memory for storing data requests (and their respective contents) and vector data and non-vector data that is retrieved from database 106, and (3) optionally, non-volatile memory.

Main memory 109 may comprise volatile, random-access memory accessible to the DBMS 100. Main memory 109 may store vector storage 112 and an HNSW vector index 115. The vector storage 112 may comprise a segmented array that stores one or more vectors from the database 106 and their associated metadata. The HNSW vector index 115 may comprise a multi-layer graph that indexes vector from the vector storage 112. Both the vector storage 112 and the HNSW vector index 115 are discussed in greater detail below.

### HNSW Vector Index

The HNSW vector index 115 is a multi-layer, in-memory graph. Each layer of the graph comprises vertices, each vertex corresponding to a vector. The lowest layer of the graph contains vertices of all of the vectors in the indexed data set. Higher layers of the HNSW vector index 115 have a decaying fraction of the vertices in the layer below.

Various hyperparameters may be used in HNSW vector index 115 construction. For example, the hyperparameter M, referred to as the “neighbor count”, is the number of neighbors that each vertex is connected to on each layer. Vectors in layer 0 (the lowest layer) may have double that number of neighbors (e.g., 2M neighbors). In each layer, vertices are connected to their approximate M closest neighbors using edges that are used to walk the graph. At the lowest layer (“layer 0”), the number of neighbors of each vertex may be different than the number of neighbors of each vertex at higher layers, such as 2M. The vertices at higher layers are on average much farther from each other (relative to lower layers) and, therefore, allow traversal of long distances.

A probability distribution function may be defined based on M to determine whether a vertex is to be inserted in a layer that is above the lowest layer. The probability distribution function is such that probabilities decay with higher layers. When the probability drops below 1e-9, then no more layers are added. An example probability distribution function is

$$p ( Layer ) = \frac{1 - \frac{1}{M}}{{M}^{Layer}}$$

For example, regarding hyperparameter R, when a new vertex (corresponding to a new vector) is inserted into an HNSW vector index, a random number R between [0.0, 1.0] is generated. A new vertex is always inserted into layer 0. A new vertex is inserted into higher layers up to a layer i if:

$$R = p ( i - 1 ) + p ( i - 2 ) + … + p ( 0 )$$

In an example, with M=10, if R=0.991, then the new vertex is inserted in layers 0 and 1. Any suitable promotion strategy may be used, however. As another example, the dataset may be pre-process to find k-medoids, and those may be promoted in upper layers.

An HNSW hyperparameter that is used for construction is referred to as “ef Construction” and refers to the number of vertices to consider within a layer when looking for the closest M vertices (or closest 2M vertices in layer 0) to which to connect a new vertex. Larger values for this parameter improve index quality but slow down construction. An example value for this parameter is 2M (or 4M for layer 0).

An HNSW hyperparameter that is used in searching is referred to as “efSearch” and refers to the number of vertices to remember in each layer when searching for the K nearest neighbors in a top-K search. Larger values of this parameter improve search quality but slow down searches. An example value for this parameter is 2K (or double the number of desired K matches).

To perform a similarity search using the HNSW vector index 115 given a query vector, a search process may start from the highest layer of the graph. The search process may proceed to the next layer of the graph each time a nearest neighboring node to the query vector is greedily found in the current layer. The nearest neighbor in a layer may be used as an entry point to the layer immediately below. The nearest neighboring node that is found in the lowest layer of the graph then becomes the result of the similarity search.

The number of operations to find the nearest neighboring node in a given layer may be bounded by a constant. Considering that the number of layers in a graph is logarithmic, the total computational complexity of the search process may be O(log n).

### Process for Parallel HNSW Vector Index Construction

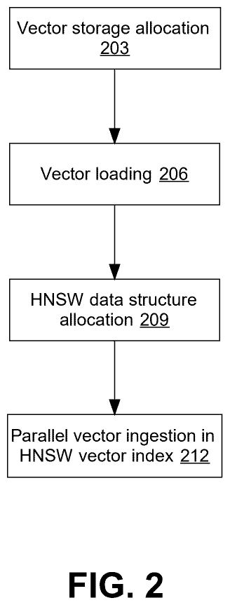

FIG. 2 is a flow diagram that illustrates an example of a process for parallel HNSW vector index 115 construction, in an embodiment. The flow diagram of FIG. 2 provides merely an example of the many different types of functional arrangements that may be employed to implement the depicted process.

At step 203, the main memory vector storage 112 and the graph data structures that will make up the HNSW vector index 115 are allocated. The vector storage 112 is allocated from a per-index slab allocator that is built on top of a memory manager provided by the DBMS 100. Vectors and their metadata (e.g., ROWIDs, which identify the location of vectors on disk) may be stored in records allocated from a per-index slab allocator that is built on top of a memory manager provided by the DBMS 100. A vector may be accessed using a pointer to its associated record that is stored in a segmented array that comprises the vector storage 112. The vector store segmented array may therefore provide a way to index vectors using an identifier. This identifier is the vector identifier (“VID”), which may represent the position of a vector in the vector storage 112.

The multilayer graph is created from these graph data structures, each of which represents a layer in the graph. An exponentially decaying probability distribution, which is discussed in more detail above, is used to determine how many layers are in the graph, how many vectors are in each layer, and to which layer each vector is assigned (i.e., the highest layer in which the vector can be found), also known as the “vector level”.

At step 206, the vectors and their metadata are loaded into the main memory vector storage 112. Stored inside the vector storage 112 is, for each segment of the vector storage 112 segmented array, a representation of an individual vector and metadata, such as a ROWID that identifies the location of that vector on disk. Vectors and ROWIDs are read from disk.

At step 209, the vectors are ingested into the HNSW vector index 115. Vectors from the main memory vector storage 112 are inserted into the graph data structures for each layer of the HNSW graph, first sequentially and then in parallel. This initial sequential insertion may be performed to have a better-connected graph. Starting with parallel ingestion may result in navigable small world properties not being respected because of poorly-connected top layers. The poor connection of the top layers may propagate to lower layers, resulting in disconnected regions in the lower layers of the graph, which may impact search latency and recall.

### Work Division

The input to vector ingestion may include a sequence of VIDs and vector levels. In some implementations, this sequence of vector levels and VIDs may be split into chunks of equal size based on a degree of parallelism provided by a user. Each of these chunks is assigned to a worker so that the worker may insert the corresponding vectors into the HNSW vector index 115. While each worker processes a same number of vectors, this method of work division may introduce load imbalance across the workers.

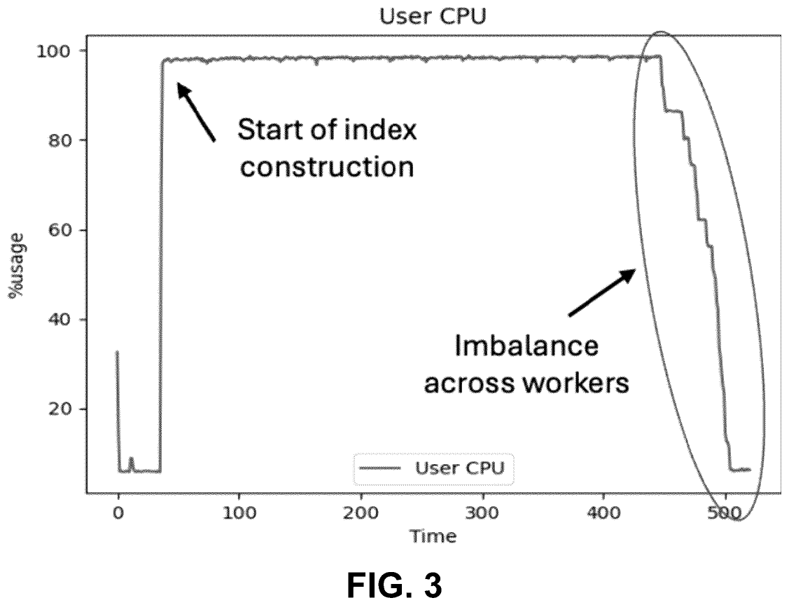

FIG. 3 shows an example of such an imbalance across workers. The example graph shown in FIG. 3 plots CPU utilization on the y-axis and the time taken to construct the HNSW vector index 115 on the x-axis. The CPU utilization progressively drops at the end of the parallel vector ingestion process. In practice, this means that some workers finish ingesting vectors sooner than others and then remain idle while those other workers are still ingesting vectors.

The load imbalance issue is caused by the high variability of ingestion time per vector ingestion due to the nature of the HNSW vector index 115. Ingestion of one vector involves multiple k-NN searches to find the nearest neighbor to the vector being ingested in each layer—a 1-NN search for the upper layers of the graph and an efConstruction-NN search for the lowest layer of the graph. A k-NN search is a search for the k nearest neighbors of a vector. Nevertheless, the k-NN search time is not the same per vector ingestion. The k-NN search time depends on how quickly the k-NN search converges to nearest neighbor candidates, and the search time increases as the graph increases in size with more vector ingestions.

### Flexible Work Division

The flexible work division approach disclosed herein overcomes issues with load imbalance in parallel vector ingestion, such as the load imbalance illustrated by FIG. 3. The flexible work division approach may improve load balancing in parallel HNSW vector index construction in various different ways.

The flexible work division approach may use fine-grain tasks to significantly reduce the impact of the high variability of ingestion time per vector ingestion. Each task may be responsible for ingesting less data than in the case of coarse-grain tasks that are based on DOP. Each worker may have sufficient “work” to perform independently from other workers, which enables the “work” to be distributed evenly across available computational resources.

The flexible work division approach may follow a lazy task creation strategy. Pre-computing tasks increases memory overhead, may force the construction algorithm to commit a priori to a specific task size, and may increase the task scheduling overhead (if a coordinator is responsible for submitting the tasks for execution). The lazy task creation strategy, however, may keep the cost of creating fine-grain tasks low. Instead of pre-computing tasks, each worker may be responsible for creating its next task when it finishes processing its current task. For example, upon finishing a task, a worker may determine whether there are more vectors to be ingested. If so, the worker may compute the next range of vectors that the worker will ingest. If there are no more vectors to be ingested, the worker may terminate its execution.

The flexible work division approach may use a tunable task size according to the characteristics of the HNSW vector index 115. For example, the size of the fine-grain tasks may depend on the M and the type of distance function used. In addition, task size may be dynamically tuned at runtime to follow a temporal constraint.

The flexible work division approach and lazy task creation enables additional parallelism to be exploited if it becomes available and thereby speed up parallel HNSW vector ingestion. For example, if a new worker is added to the existing pool of workers, the new worker can begin ingesting ranges of vector immediately because there are no predetermined tasks and assignments of tasks to workers. This flexibility may be useful to exploit opportunistic parallelism.

### Shared Latch

Workers may use a shared latch on the sequence of VIDs and vector levels to ensure that two or more workers do not attempt to ingest duplicate or overlapping ranges of vectors. To create a task, a worker may acquire the latch in exclusive mode. Once the worker has acquired the latch, the worker may determine the next range of vectors to ingest. Determining the next range of vectors to be ingested is orders of magnitude faster than the vector ingestion process. And even with tasks of extremely small size, this lightweight synchronization mechanism does not impose an overhead in parallel HNSW vector index 115 construction. When the worker has determined the next range of vectors to ingest, the worker may release the shared latch. The worker may then begin the vector ingestion process.

### Fine-Grain Tasks

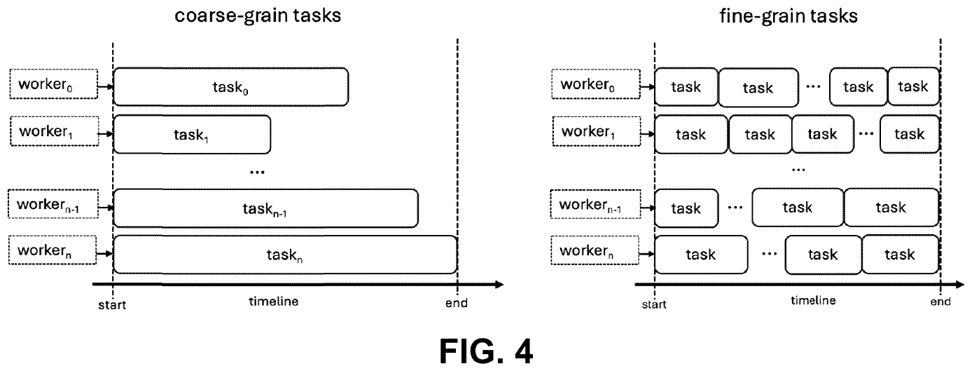

FIG. 4 shows an example of how the usage of fine-grain tasks improves load balancing and maximizes resource utilization compared to coarse-grain tasks. When using coarse-grain tasks, in contrast, not all the available resources are utilized, and the slowest worker determines the overall vector ingestion time.

Determining the size of the fine-grain tasks may not be fixed for each index construction. Task size may be determined based on the maximum number of neighbors M the type of distance function (e.g., Euclidean distance, cosine distance, etc.), various characteristics of the HNSW vector index 115, temporal constraints, and other factors. For example, if M is high (e.g., greater than 64-72), ingesting a range of vectors may be more expensive than in case of a lower M (e.g., 16, 32). A lower task size can therefore help to avoid the load imbalance issue.

As another example, reducing task size can help to avoid load imbalance when using a more computationally inventive distance function. Likewise, the task size may be greater when using a less computationally inventive distance function.

Because of lazy task creation, the task size may be dynamically tuned at runtime to follow some temporal constraint. For example, each worker may increase or reduce the task size based on time measurements from previous tasks. To illustrate, if the execution time of an immediate previous task came within a given range of a predefined time threshold, the workers next task may have a decreased size. That way, the worker may ensure that the task execution time does not exceed the predefined time threshold.

### Example Process for Ingesting Ranges of Vectors

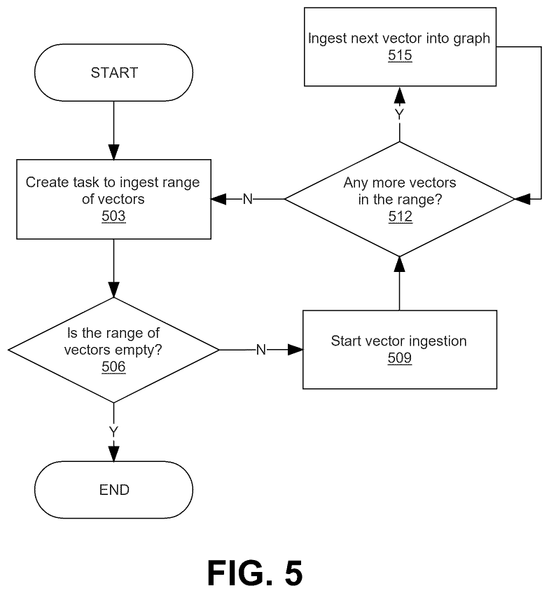

FIG. 5 is a flow diagram that illustrates an example of a process by which a worker ingests ranges vectors in an HNSW vector index 115, in an embodiment. The flow diagram of FIG. 4 provides merely an example of the many different types of functional arrangements that may be employed to implement the depicted process.

At step 503, the worker creates a task to ingest a range of vectors. Instead of tasks being pre-computed when parallel vector ingestion begins, the worker lazily creates a new task when the process depicted in FIG. 5 begins or after the worker finishes processing a previous task, as in step 512 below. When creating a task, the worker acquires a shared latch on a sequence of VIDs and vector levels in exclusive mode. The sequence of VIDs and vector levels represent the vectors to be ingested. The worker computes the range of vectors that it will ingest. The worker identifies the lowest-numbered VID in the sequence that has not yet been ingested. Starting from that VID, the worker computes the range of vectors that will be ingested. The number of vectors in the range of vectors depends on the task size, which may be determined based on the value of M, the distance function used, temporal constraints, and other characteristics of the HNSW vector index 115. The worker then releases the latch.

At step 506, the worker determines whether the range of vectors is empty. If the range of vectors is empty, the process terminates. If the range of vectors is not empty, then the process proceeds to step 509.

At step 509, the worker starts vector ingestion. Each vector in the range of vectors is randomly assigned an integer value that represents its vector level, which is the highest layer of the HNSW graph in which a particular vector can be inserted. Vector levels may be randomly selected based on, for example, an exponentially decaying probability distribution normalized by a non-zero multiplier mL.

At step 512, the worker determines whether there are any more vectors in the range of vectors that have not been ingested. If there are more vectors in the range of vectors that have yet to be ingested, the current task is not yet complete and the process proceeds to step 515. If all the vectors in the range of vectors have been ingested, the current task has been completed and the process proceeds back to step 503, where the worker lazily creates a new task to ingest another range of vectors.

At step 515, the worker ingests the next vector in the range of vectors. The worker inserts the next vector into the HNSW graph from the lowest layer to the layer matching the next vector's designated vector level. In each such layer, the worker creates edges between the next vector and its M nearest neighbors identified using an ef Construction-NN greedy search (or, in the case of the lowest layer, the 2M nearest neighbors). The process for vector ingestion in an HNSW vector index is described in more detail in U.S. application Ser. No. 19/038,504 (Atty. Docket. No. 50277-6371). When the worker has finished ingesting the next vector in the HNSW vector index 115, the process proceeds back to step 512.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

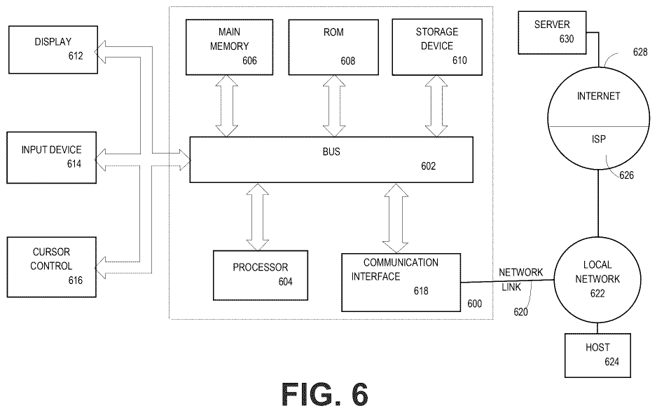

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Software Overview

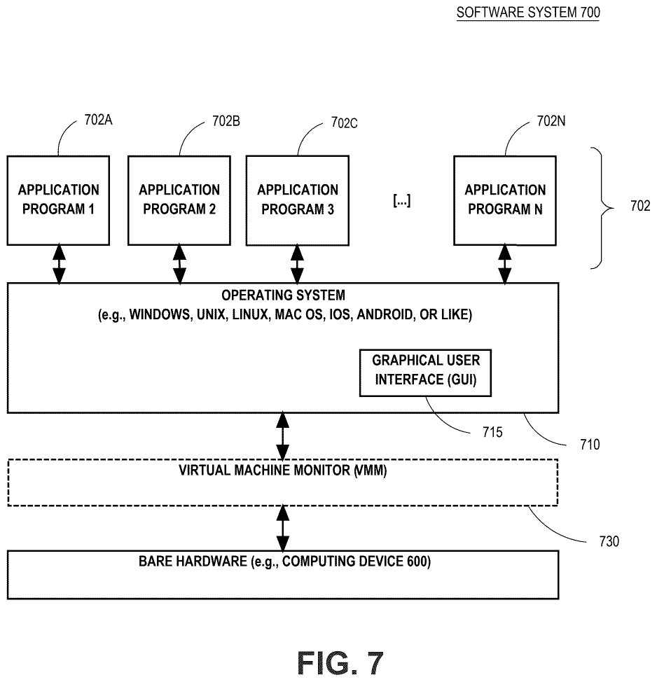

FIG. 7 is a block diagram of a basic software system 700 that may be employed for controlling the operation of computing system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computing system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 700 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
a database management system (DBMS) storing in memory representations of a plurality of vectors from a database; and
a plurality of workers ingesting, in parallel, the plurality of vectors into a hierarchical navigable small world (HNSW) vector index stored in memory, wherein the HNSW vector index indexes the plurality of vectors, and an individual worker of the plurality of workers ingesting one or more vectors of the plurality of vectors into the HNSW vector index comprises:
the individual worker creating a task to ingest a range of vectors of the one or more vectors into the HNSW vector index; and
the individual worker ingesting individual vectors of the range of vectors into the HNSW vector index;
wherein the method is performed by one or more computing devices.

2. The method of claim 1, wherein the individual worker creating the task to ingest the range of vectors into the HNSW vector index comprises:
the individual worker acquiring, in an exclusive mode, a shared latch on a sequence of at least a plurality of vector identifiers corresponding to the plurality of vectors;
the individual worker computing the range of vectors to be ingested; and
the individual worker releasing the shared latch.

3. The method of claim 1, wherein the individual worker ingesting the one or more vectors into the HNSW vector index further comprises:
the individual worker determining a size of the task based at least in part on a maximum number of neighbors for individual vectors indexed by the HNSW vector index.

4. The method of claim 1, wherein the individual worker ingesting the one or more vectors into the HNSW vector index further comprises:
the individual worker determining a size of the task based at least in part on a predetermined time limit.

5. The method of claim 1, wherein the individual worker ingests individual vectors of the range of vectors into the HNSW vector index in response to determining that the range of vectors is not empty.

6. The method of claim 1, wherein the task is a first task and the range of vectors is a first range of vectors, and the individual worker ingesting the one or more vectors into the HNSW vector index further comprises:
the individual worker creating a second task to ingest a second range of vectors of the one or more vectors;
the individual worker determining whether the second range of vectors is empty; and
in response to determining that the second range of vectors is empty, the individual worker terminating.

7. The method of claim 1, wherein the individual worker ingesting the one or more vectors into the HNSW vector index further comprises:
the individual worker determining that the range of vectors fails to comprise an additional vector to be ingested into the HNSW vector index.

8. The method of claim 7, wherein the task is a first task and the range of vectors is a first range of vectors, and the individual worker ingesting the one or more vectors into the HNSW vector index further comprises:
in response to determining that the first range of vectors fails to comprise the additional vector to be ingested into the HNSW vector index, the individual worker creating a second task to ingest a second range of vectors into the HNSW vector index.

9. The method of claim 1, wherein the task is a first task and the range of vectors is a first range of vectors, and the individual worker ingesting the one or more vectors into the HNSW vector index further comprises:
creating a second task to ingest a second range of vectors of the one or more vectors into the HNSW vector index, wherein a size of the second task is less than a size of the first task in an instance in which an execution of the first task meets a predefined threshold.

10. The method of claim 1, further comprising sequentially inserting a portion of the plurality of vectors into the HNSW vector index.

11. One or more non-transitory storage media storing instructions which, when executed by one or more computing devices, cause:
a database management system (DBMS) storing in memory representations of a plurality of vectors from a database; and
a plurality of workers ingesting, in parallel, the plurality of vectors into a hierarchical navigable small world (HNSW) vector index stored in memory, wherein the HNSW vector index indexes the plurality of vectors, and an individual worker of the plurality of workers ingesting one or more vectors of the plurality of vectors into the HNSW vector index comprises:
the individual worker creating a task to ingest a range of vectors of the one or more vectors into the HNSW vector index; and
the individual worker ingesting individual vectors of the range of vectors into the HNSW vector index.

12. The one or more non-transitory storage media of claim 11, wherein the individual worker creating the task to ingest the range of vectors into the HNSW vector index causes:
the individual worker acquiring, in an exclusive mode, a shared latch on a sequence of at least a plurality of vector identifiers corresponding to the plurality of vectors;
the individual worker computing the range of vectors to be ingested; and
the individual worker releasing the shared latch.

13. The one or more non-transitory storage media of claim 11, wherein the individual worker ingesting the one or more vectors into the HNSW vector index further causes:
the individual worker determining a size of the task based at least in part on a maximum number of neighbors for individual vectors indexed by the HNSW vector index.

14. The one or more non-transitory storage media of claim 11, wherein the individual worker ingesting the one or more vectors into the HNSW vector index further causes:
the individual worker determining a size of the task based at least in part on a predetermined time limit.

15. The one or more non-transitory storage media of claim 11, wherein the individual worker ingests individual vectors of the range of vectors into the HNSW vector index in response to determining that the range of vectors is not empty.

16. The one or more non-transitory storage media of claim 11, wherein the task is a first task and the range of vectors is a first range of vectors, and the individual worker ingesting the one or more vectors into the HNSW vector index further causes:
the individual worker creating a second task to ingest a second range of vectors of the one or more vectors;
the individual worker determining whether the second range of vectors is empty; and
in response to determining that the second range of vectors is empty, the individual worker terminating.

17. The one or more non-transitory storage media of claim 11, wherein the individual worker ingesting the one or more vectors into the HNSW vector index further causes:
the individual worker determining that the range of vectors fails to comprise an additional vector to be ingested into the HNSW vector index.

18. The one or more non-transitory storage media of claim 17, wherein the task is a first task and the range of vectors is a first range of vectors, and the individual worker ingesting the one or more vectors into the HNSW vector index further causes:
in response to determining that the first range of vectors fails to comprise the additional vector to be ingested into the HNSW vector index, the individual worker creating a second task to ingest a second range of vectors into the HNSW vector index.

19. The one or more non-transitory storage media of claim 11, wherein the task is a first task and the range of vectors is a first range of vectors, and the individual worker ingesting the one or more vectors into the HNSW vector index further causes:
creating a second task to ingest a second range of vectors of the one or more vectors into the HNSW vector index, wherein a size of the second task is less than a size of the first task in an instance in which an execution of the first task meets a predefined threshold.

20. The one or more non-transitory storage media of claim 11, wherein the instructions, when executed by the one or more computing devices, further cause:
sequentially inserting a portion of the plurality of vectors into the HNSW vector index.
